(19) United States
(12) Patent Application Publication
(10) Pub. No.: US 2024/0231796 A1
(43) Pub. Date: Jul. 11, 2024

(54) System For Publishing Embedded Web Application With Atomic Version Control

(71) Applicant: Salesforce, Inc., San Francisco, CA (US)

(72) Inventors: Sankara Jaya Prakash Nimmagadda, Austin, TX (US); Benjamin Drasin, Portland, OR (US); Sudhakara Reddy Peddi, Irvine, CA (US)

(73) Assignee: Salesforce, Inc., San Francisco, CA (US)

(21) Appl. No.: 18/094,267

(22) Filed: Jan. 6, 2023

(51) Int. Cl. G06F 8/65; G06F 9/445; H04L 51/046

(52) U.S. Cl. CPC G06F 8/65; G06F 9/44505; H04L 51/046

(57) ABSTRACT

Disclosed herein are system, method, and computer program product embodiments for publishing an embedded web application with atomic version control. An embodiment operates by generating an updated version of an embedded code in response to receiving a request to publish an updated embedded web application. The embodiment then generates an embedding code and an application configuration corresponding to the updated version of the embedded code in response to a determination that the embedded web application was published successfully. The embodiment then stores the embedding code and the application configuration.

### BACKGROUND

One or more implementations relate to the field of publishing embedded web applications.

A web application is an application software delivered over the Internet and is run in a web browser. Modern web applications are often complex and require a publishing system to keep the application cohesive as it is updated with new views, components, and configurations. A publishing system for web applications typically has a development phase, where an administrator configures and designs the website. A publishing system further includes a publishing process where various design resources are converted and compiled into resources that are subsequently consumed by runtime processes which serve the resources to users on the Internet.

An embedded web application is usually enclosed inside an iframe and embedded within a larger parent website. Hence, updating an embedded web application may necessitate changes to the parent webpage and/or changes to the code that enable communication between the embedded application and the parent webpage. A mismatch between versions of various code sets corresponding to the embedded application may result in an inconsistent user experience. Accordingly, what is needed is a system to facilitate a consistent versioned publication of embedded web applications.

### BRIEF DESCRIPTION OF THE DRAWINGS

The accompanying drawings are incorporated herein and form a part of the specification.

FIG. 1 illustrates a block diagram of an exemplary embedded web application, in accordance with some embodiments.

FIG. 2 illustrates a block diagram of an exemplary method for publishing an embedded web application, in accordance with some embodiments.

FIG. 3 illustrates a block diagram of an exemplary runtime loading sequence for publishing embedded web applications with atomic version control, in accordance with some embodiments.

FIG. 4 illustrates an exemplary method for publishing an embedded web application with atomic version control, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for publishing an embedded web application with atomic version control.

According to some embodiments, when a web application is updated and published, the publishing system may have a means of grouping the changes into a cohesive set and assigning it a unique version name or a unique version number. According to some aspects, version control with a publishing system prevents mixing newly published files with content from previously published versions of software and ensures a consistent user experience. According to some aspects, a publishing system may publish all of the resources except the initial resource (e.g., home page/index.html) using a path unique to the version being published and subsequently replaces the initial resource with an updated version referencing all of the new resources.

According to some aspects, an embedded web application is enclosed within a larger parent webpage, and an embedding code enables the communication between the embedded web application and the parent webpage. According to some aspects, the owner of an embedded web application may wish to update the application in such a way as to require changes in the parent webpage, for example, changes to the dimensions of the iframe, changes to the messages exchanged between the parent webpage and the embedded web application, and the like. Furthermore, the administrator of the embedded web application may not be the same as the owner of the parent webpage. Hence, coordinating concurrent updates to the parent webpage and the embedded web application might be difficult.

According to some aspects, an embedded web application may utilize a set of externally-supplied configurations obtained at runtime. According to some aspects, a real-time application server may be utilized to deliver external embedding code and application configuration that is consistent with the published version of the embedded web application. Maintaining consistency between the published version of the embedded web application and the embedding code and configuration avoids code mismatches that may result in an inconsistent end-user experience.

Various embodiments of these features will now be discussed with respect to the corresponding figures.

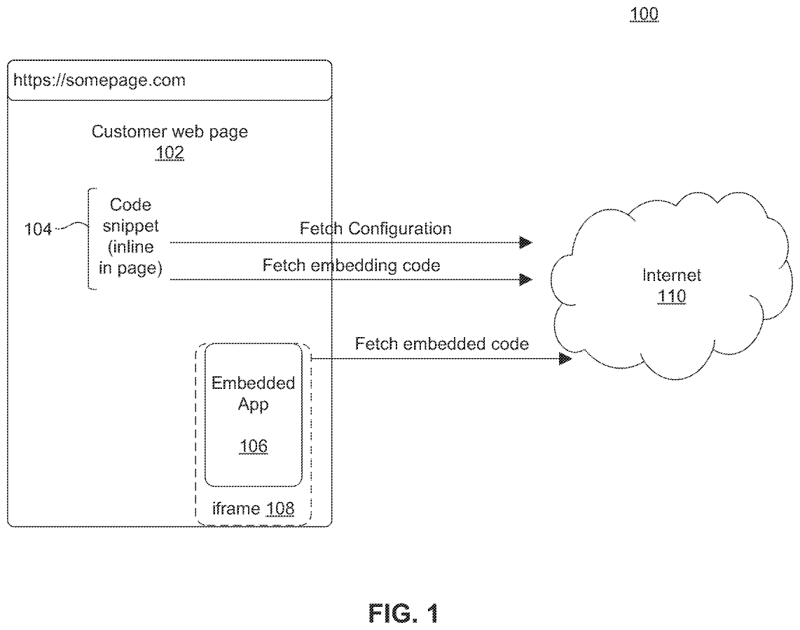

FIG. 1 illustrates a block diagram of an exemplary embedded web application, in accordance with some embodiments. As illustrated in FIG. 1, embedded web application 106 is enclosed within a larger parent web page 102 (e.g., a consumer webpage). Exemplary applications that may be embedded in a webpage include embedded advertisements, embedded videos (e.g., YouTube, Vimeo, etc.), discussion threads (e.g., Disqus, Facebook comments), social media posts, and real-time messaging applications (e.g., chat applications and the like).

According to some aspects, the parent webpage 102 includes an iframe 108, and the embedded web application 106 is enclosed within the iframe 108. The parent web page 102 also includes an in-lined code snippet 104. According to some aspects, embedded application 106 utilizes various sets of code, including an embedding code, an embedding code, and an application configuration. According to some aspects, an external application server is used to deliver the embedding code and application configuration corresponding to the published version of the embedded application to the customer webpage 102.

According to some aspects, all the embedding code may be contained in a code snippet. Alternatively, for complex web applications, the embedding code may be included in the code snippet as attributes for the iframe, as a free JavaScript, or as a separate external file. According to some aspects, using the code snippet 110, application configuration and embedding code are loaded from an external application server located in the Internet 110. As illustrated in FIG. 1, code snippet 104 includes instructions to create a request to an application server to fetch application configuration and embedding code corresponding to the published version of the embedded application.

According to some aspects, the configuration code may specify various attributes of the embedded application, and the embedding code may include instructions that enable communication between the embedded application 106 and the parent page 102.

The embedding code is consumed by the parent page 102 and may include a Javascript function to create the iframe 108. According to some aspects, the embedding code may also include a URL of the embedded code.

According to some aspects, the embedded code implements the embedded application 106 and is loaded into an iframe 108 inside the parent webpage 102. According to some aspects, the embedded code is generated by a third-party website or server and is loaded into the iframe 108. According to some aspects, the code snippet 104 is kept to a minimal size, and the configuration code and the embedding code are loaded externally

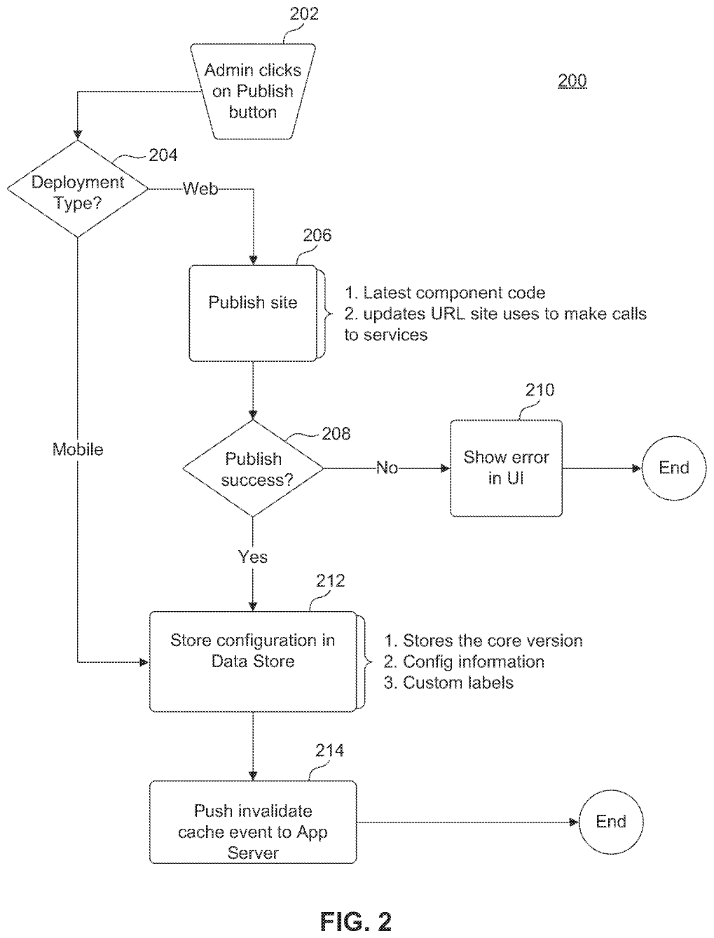

FIG. 2 illustrates a block diagram of an exemplary process for publishing an embedded web application, in accordance with some embodiments. FIG. 2 may be described with reference to elements from FIG. 1.

At 202, a website administrator may click on a publish button to publish an updated embedded web application. According to some aspects, a determination is made at 204 as to whether the deployment is a web deployment or a mobile deployment. According to some aspects, based on a determination that the deployment type is a web deployment, an application programming interface (API) call may be made to a content management system to publish the site. According to some aspects, the publishing process at 206 prepares XML pages and component code to be consumed as content. According to some aspects, an updated component code is generated at 206, and a URL to makes calls to services is updated.

At 208, a determination is made as to whether the publishing process is a success. According to some aspects, if the publish process is a success, the procedure to implement atomic version control is subsequently executed. Alternatively, if the publish process is not a success, at 210, an error message is displayed at the administrator's user interface. At 212, based on a determination that the publishing process is a success, a set of resources containing the data needed to create the embedding code are generated. The generated set of resources may be stored in a persistent entity at a data store core server. According to some aspects, embedding code and application configuration corresponding to the published embedded application are generated. The generated embedding code and application configuration, along with corresponding custom labels, may also be stored in a persistent entity at a core server.

At 214, an invalid cache event is pushed to a cache server. According to some aspects, the cache service is invalidated so that the embedding code and the configuration corresponding to the latest published version are fetched from the core server.

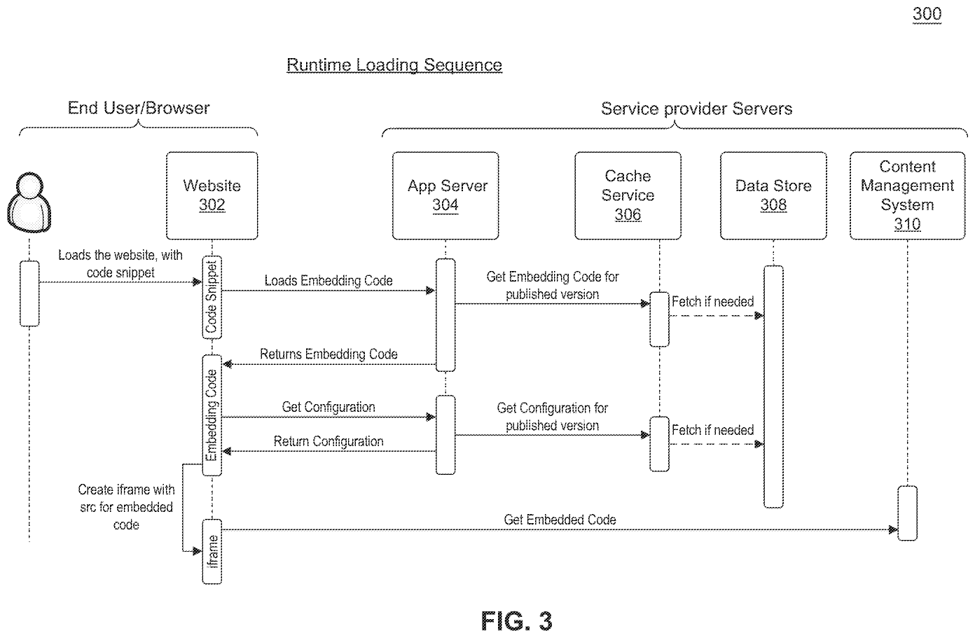

FIG. 3 illustrates a block diagram of an exemplary runtime loading sequence for publishing embedded web application with atomic version control, according to some embodiments.

According to some aspects, the exemplary system comprises an application server 304, a cache service 306, a data store 308, and a content management system 310. Furthermore, website 302 includes a webpage that may host an embedded web application. According to some aspects, the webpage includes an in-lined code snippet that communicates with an application server 304.

According to some aspects, when a user loads the webpage with the code snippet, the in-line code snippet sends a request to the application server 304 to fetch appropriate embedding code corresponding to the embedded web application last published by the user. According to some aspects, the request sent by the code snippet includes an identifier corresponding to the customer and/or an identifier corresponding to the website 302. The request may also include an identifier corresponding to the embedded application. According to some aspects, the application server 304 performs a look-up to determine the embedding code corresponding to the published version of the embedded web application. The application server may obtain the embedding code corresponding to the published version of the embedded web application from a cache service 306.

According to some aspects, a copy of the embedding code and the application configuration corresponding to the published version of the embedded application are stored at a data store 308. According to some aspects, the data store 308 may be a persistent data storage device. If the embedding code corresponding to the published version of the embedded web application is unavailable at the cache service 306 or if the cache service was indicated to be invalid, the appropriate embedding code is fetched from the data store 308, and the application server 304 returns the embedding code to the website 302.

According to some aspects, once the appropriate embedding code is received at the webpage, the embedding code generates a request to the application server 304 to fetch the appropriate application configuration corresponding to the published embedded web application. The application server 304 may obtain the application configuration corresponding to the published version of the embedded web application from a cache service 306. Alternatively, if the application configuration corresponding to the published version of the embedded web application is unavailable at the cache service 306 or if the cache service was indicated to be invalid, the appropriate version of the application configuration is fetched from the data store 308, and the application server 304 returns it to the website 302.

According to some aspects, the embedding code creates an iframe that may be used for encapsulating the embedded code corresponding to the embedded application. In addition, the embedding code uses the received application configuration and generates a request to a content management system 310 to fetch the appropriate embedded code. According to some aspects, the content management system 310 returns the embedded code corresponding to the published version of the embedded application. The embedded code is encapsulated within the iframe to implement the embedded application on the webpage.

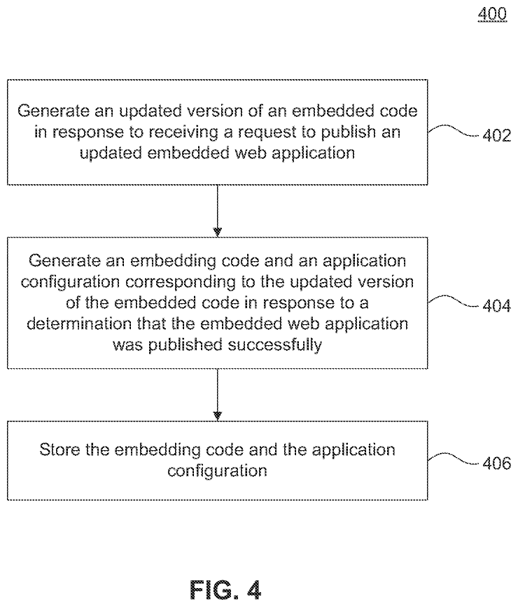

FIG. 4 is a flowchart for method 400 for publishing an embedded web application with atomic version control, according to an embodiment. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to those example embodiments.

At 402, an updated version of an embedded code is generated in response to receiving a request to publish an updated embedded web application. According to some aspects, the embedded code includes instructions for implementing the updated embedded web application at a web client. According to some aspects, the embedded web application is a multi-tenant embedded web application. According to some aspects, the embedded code is generated by a content management system. According to some aspects, the embedded web application is a real-time messaging application.

At 404, an embedding code and an application configuration corresponding to the updated version of the embedded code are generated in response to a determination that the embedded web application was published successfully. According to some aspects, the embedding code includes instructions for creating an iframe for embedding the web application within a parent page at a web client. According to some aspects, the application configuration includes a plurality of attributes of an iframe for embedding the web application within a parent page at a web client. According to some aspects, the application configuration includes information corresponding to the dimensions of the iframe, color attributes, layout of the text boxes, and the input fields corresponding to the embedded application. According to some aspects, the application configuration is generated in the format of a Javascript object notation (JSON) object.

At 406, the embedding code and the application configuration are stored on a data store server. According to some aspects, the data store server includes a persistent storage device that stores the embedding code and the application configuration. According to some aspects, an end-user website may send a request to an application server 304 to fetch embedding code corresponding to the user's published version of the embedded web application. According to some aspects, the application server may perform a look-up to determine the appropriate embedding code corresponding to the published version of the embedded web application. The application server may obtain the embedding code corresponding to the user's published version of the embedded web application.

According to some aspects, an application server sends the embedding code and the application configuration to a web client in response to receiving a request generated by an in-line code snippet at the web client. According to some aspects, once the embedding code and the application configuration are stored in a persistent storage device, the application server cache containing an embedding code and an application configuration corresponding to a previous version of the embedded code is invalidated.

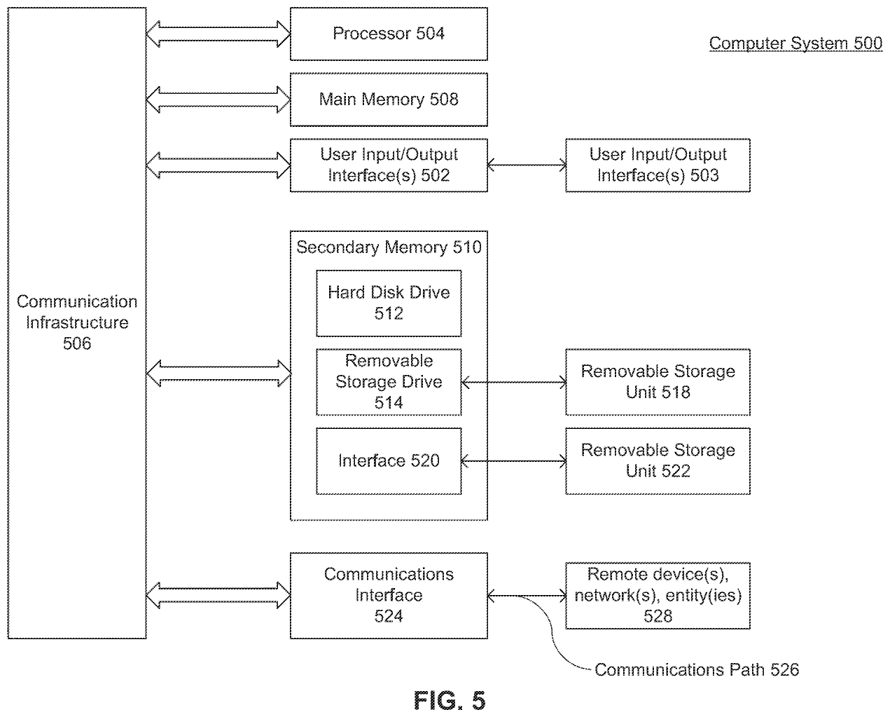

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer uscable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
generating an updated version of an embedded code in response to receiving a request to publish an updated embedded web application;
generating an embedding code and an application configuration corresponding to the updated version of the embedded code in response to a determination that the embedded web application was published successfully; and
storing the embedding code and the application configuration.

2. The method of claim 1, further comprising:
sending the embedding code and the application configuration to a web client in response to receiving a request generated by an in-line code snippet at the web client.

3. The method of claim 1, further comprising:
invalidating an application server cache containing an embedding code and an application configuration corresponding to a previous version of the embedded code.

4. The method of claim 1, wherein the embedding code includes instructions for creating an iframe for embedding the web application within a parent page at a web client.

5. The method of claim 1, wherein application configuration includes a plurality of attributes of an iframe for embedding the web application within a parent page at a web client.

6. The method of claim 1, wherein the embedded code includes instructions for implementing the updated embedded web application at a web client.

7. The method of claim 1, wherein the embedded web application is a real-time messaging application.

8. A system, comprising:
a memory; and
at least one processor coupled to the memory and configured to:
generate an updated version of an embedded code in response to receiving a request to publish an updated embedded web application;
generate an embedding code and an application configuration corresponding to the updated version of the embedded code in response to a determination that the embedded web application was published successfully; and
store the embedding code and the application configuration.

9. The method of claim 8, wherein the at least one processor is further configured to:
send the embedding code and the application configuration to a web client in response to receiving a request generated by an in-line code snippet at the web client.

10. The system of claim 8, wherein the at least one processor is further configured to:
invalidate an application server cache containing an embedding code and an application configuration corresponding to a previous version of the embedded code.

11. The system of claim 8, wherein the embedding code includes instructions for creating an iframe for embedding the web application within a parent page at a web client.

12. The system of claim 8, wherein application configuration includes a plurality of attributes of an iframe for embedding the web application within a parent page at a web client.

13. The system of claim 8, wherein the embedded code includes instructions for implementing the updated embedded web application at a web client.

14. The system of claim 8, wherein the embedded web application is a real-time messaging application.

15. A non-transitory computer-readable medium (CRM) having instructions stored thereon that, when executed by at least one computing device, causes the at least one computing device to perform operations comprising:
generating an updated version of an embedded code in response to receiving a request to publish an updated embedded web application;
generating an embedding code and an application configuration corresponding to the updated version of the embedded code in response to a determination that the embedded web application was published successfully; and
storing the embedding code and the application configuration.

16. The non-transitory CRM of claim 15, further comprises:
sending the application configuration and the embedding code to a web client in response to receiving a request generated by an in-line code snippet at the web client.

17. The non-transitory CRM of claim 15, further comprises:
invalidating an application server cache containing an application configuration and an embedded code corresponding to a previous version of the embedded code

18. The non-transitory CRM of claim 15, wherein the embedding code includes instructions for creating an iframe for embedding the web application within a parent page at a web client.

19. The non-transitory CRM of claim 15, wherein application configuration includes a plurality of attributes of an iframe for embedding the web application within a parent page at a web client.

20. The non-transitory CRM of claim 15, wherein the embedded code includes instructions for implementing the updated embedded web application at a web client.
